(19) United States
(12) Patent Application Publication
(10) Pub. No.: US 2018/0222212 A1
(43) Pub. Date: Aug. 9, 2018

(54) AN APPARATUS AND A METHOD FOR PRINTING ONTO CONTAINERS WITH ERROR DETECTION

(71) Applicant: KRONES AG, Neutraubling (DE)

(72) Inventors: Josef MAYER, Regensburg (DE); Florian LAUTERBACH, Neutraubling (DE); Andreas KRAUS, Lappersdorf (DE); Andreas SONNAUER, Woerth (DE)

(21) Appl. No.: 15/320,560

(22) PCT Filed: Aug. 31, 2015
(86) PCT No.: PCT/EP2015/069872

§ 371 Date: Dec. 20, 2016

(30) Foreign Application Priority Data
Aug. 29, 2014 (DE) 10 2014 112 483.9

(51) Int. Cl. B41J 3/407; B41J 3/54; G06T 7/00; B41F 17/08; B41F 33/00

(52) U.S. Cl. CPC B41J 3/4073; B41J 3/543; B41F 33/0036; B41F 17/08; G06T 7/0004

(57) ABSTRACT

An apparatus for printing onto containers is provided, including a transport device that transports the containers to be printed along a specified transport path, wherein the transport device includes a carrier and a plurality of holding devices provided on said carrier for holding the containers to be printed in such a way that the containers to be printed can be transported in an individualised manner, including a first printing unit that prints a specified image element onto the containers, including a second printing unit that is provided along the transport path of the containers after the first printing unit and prints a second image element onto the containers already printed with the first printing element.

The present invention relates to an apparatus and a method for printing onto containers. It has been known for a long time from the prior art that containers are provided with labels. Various types of labels are known, such as for example body labels, shoulder labels and the like. In recent times, however, also apparatus and methods have become known which do not apply labels to the containers, but provide these containers with a print, i.e. in particular a direct print. In this connection it is possible for a printing unit to be mounted for example in a stationary manner and for the containers guided past this printing unit to be provided with a print. However, when using such printing elements, the most varied errors may occur, such as for example a failure of some printing nozzles and the like. Such errors in turn result in poor or faulty prints and thus in failures or scrap respectively.

The present invention is therefore based on the object of providing an apparatus and a method, by means of which scrap in such faulty containers can be eliminated or reduced. According to the invention, this object is achieved by the subject matters of the independent claims. Advantageous embodiments and further developments form the subject matter of the dependent claims.

An apparatus according to the invention for printing containers comprises a transport device that transports the containers to be equipped or to be printed along a specified transport path. Here, the transport device comprises a carrier and a plurality of holding devices provided on this carrier for holding the containers to be printed in such a way that the containers to be printed can be transported in an individualised manner. Further, the apparatus comprises a first printing unit that prints the containers using a specified printing element or image element. Further, the apparatus comprises a second printing unit that is provided along the transport path of the containers downstream of the first printing unit and prints (also) a second image element onto the containers that have already been printed with the first printing element or image element.

According to the invention, the apparatus comprises an inspection device provided downstream of the printing units in the transport direction of the plastics material containers, which inspects the print provided on the containers, as well as an association device that associates an inspection result of the inspection device with the printing units.

Preferably, this print is made up at least of components of the first image element and of the second image element. Preferably, this print may be made up of several of image elements, which in particular have colours that differ from each other. The inspection result may in particular be a statement regarding a quality of the print provided on the container. In particular, the inspection result may contain statements regarding the occurrence of errors in the individual prints or image elements respectively. In this context, this inspection result may identify any occurring fault.

It is therefore proposed that a certain container is printed both by the first printing unit and by the second printing unit. Preferably here, at least partially identical regions of the container are printed using both printing units. In this way, for example several colour components may be applied one after the other on the container or the outer wall of the container respectively. The inspection device can now, by way of a corresponding evaluation for example in the case of a fault, determine which printing unit has produced a fault or during which printing process faults were produced by which unit respectively.

It is thus preferably possible to detect during each inspection, which printing unit has carried out the process. If for example different colours are printed onto the container, it may already be determined by the evaluation of the respective colour or the determination of the colour respectively which printing unit has applied this print.

In a further advantageous embodiment, the holding devices include rotation devices in order to rotate the containers about the longitudinal direction thereof. In this way, not only can the containers be guided past the printing units, but they can also be rotated about their own rotational or longitudinal axis, so that it is possible to apply a print to the outside wall over wide circumferential regions of the containers.

In a further advantageous embodiment, the transport device includes a circulating carrier and in particular a rotatable carrier, on which the holding devices are provided.

In a further advantageous embodiment, the apparatus includes a rejection device that is provided downstream of the inspection device in the transport direction of the containers. This rejection device is preferably suitable or intended respectively for rejecting any containers detected as being faulty, in particular as having a faulty print, from the container flow. Advantageously, a rotary axis, about which the containers themselves can be rotated, is parallel to a rotary axis of the carrier, on which all of the holding devices are provided. Advantageously, this rotary axis extends vertically.

In a further advantageous embodiment, the inspection device has an image capturing device. By evaluating images captured in this way, a conclusion can be made in a relatively simple manner in respect of the printing unit that has produced certain components of the image, for example the red components of this image.

In a further advantageous embodiment, at least one printing unit outputs a colour. It is pointed out that within the context of the present description, black and white are also understood to be colours. Advantageously, the two printing units apply different colours onto the container.

In a further advantageous embodiment, at least one printing unit and preferably several printing units include(s) inkjet printing units. These inkjet printing units in turn may have a plurality of inkjet printing heads. These inkjet printing heads may in turn be arranged next to each other along a specified line, for example in a longitudinal direction of the container, and print in this way a closed, i.e. gap-free image.

In a further advantageous embodiment, at least one printing unit has at least one redundantly present printing element. Thus, for example, a certain printing head may be provided on a printing unit in duplicate or redundantly, i.e. during working operation, only one of these two printing heads works and the other one is in an idle mode. In this way it is possible, in the case of a failure of a printing head, to switch the printing process over to a further printing head that is redundantly present. During this time it would then be possible to replace or service said first printing head.

In a further advantageous embodiment, the apparatus includes a third printing unit that is provided along the transport path of the containers downstream of the second printing unit for printing a third image element onto the containers that have already been printed with the first image element and the second image element.

In this context it is pointed out that an image element is not necessarily understood to be a continuous image, but also for example the application of lettering or the like may be interpreted as an image element.

In a further advantageous embodiment, the apparatus also includes a fourth printing unit that is provided along the transport path of the containers downstream of the second or the third printing unit respectively and prints a fourth image element onto the containers that have already been printed with the image elements described above.

Apart from that, the apparatus could also include further printing units for printing further (colour) components onto the containers. In a further advantageous embodiment, the apparatus comprises a drying device for drying the images or image elements respectively printed onto the containers.

Preferably, at least two printing units have a distance from each other along the transport path of the plastics material preforms, which corresponds to a pitch between the transported containers or an integer multiple of this pitch. Preferably, several printing units, and preferably all of the printing units, have such a distance from each other. In this way it can be achieved that the different printing units apply prints, substantially at the same time, onto (however different) containers.

Advantageously, at least two and preferably at least three and preferably all four of the printing elements print at least partially onto the same surface region of the container.

In a further advantageous embodiment, at least one printing unit is mounted to be stationary. It would thus be possible for one, two, three or even more printing units to be mounted to be stationary and for the containers to be printed to be guided past these printing units and, as they are guided past them, to be printed with the different colour components. A printing unit mounted to be stationary is understood to mean that it may have printing heads that may be movable within certain limits (for example in order to compensate to a minor degree any movement of the containers or of a wall of the container to be printed, or to follow this movement to a limited degree respectively), but that at least components, such as for example a carrier of this printing unit, are mounted to be stationary.

In a further advantageous embodiment, at least one printing unit has a plurality of printing elements which are arranged one on top of the other in particular in the longitudinal direction of the containers to be printed.

In a further advantageous embodiment, the inspection device has a first image capturing device that is suitable for capturing spatially resolved colour images. In particular, this may be a colour camera. This imaging capturing device preferably captures at least one, preferably several images of the individual containers, and subsequently feeds them to an evaluation. On the basis of these spatially resolved colour images, a plurality of errors may be detected and, if necessary, thus eliminated.

Also, the captured images or the thus determined errors may be associated with the corresponding printing unit. In a further advantageous embodiment, the inspection device has a comparison device that compares images captured by the image capturing device with reference images. On the basis of such a comparison, errors may be determined. In addition, also a display device may be provided which outputs an inspection result and/or which outputs images of the inspected containers. Thus, an information output unit may be used to output information to a user as to which error is present and, if necessary, how this error can be eliminated.

In a further advantageous embodiment, the inspection device includes a second image capturing device that is also suitable for capturing spatially resolved images. Advantageously, this is an image capturing device that is also suitable for capturing black and white images or grey-scale images. This second image capturing device may in particular be used for identifying a faulty black and white printing unit.

In a further advantageous embodiment, the inspection device has an illumination device that illuminates the containers, in particular for the purpose of an inspection thereof. This illumination device may here directly illuminate the applied print, and the inspection device can in turn capture an image of this print thus illuminated. Also, an inspection by way of a transmitted light method would be conceivable.

By means of capturing a colour image, a conclusion may be made, as mentioned above, as to the faulty printing unit. In the course of this, the images may for example be checked according to colour models known in the printing industry, such as hexachrome. Also an evaluation according to the CMYK and a white-image standard is possible. Advantageously, not only the corresponding faulty printing unit may be identified but possibly also a printing head out of a plurality of printing heads of this printing unit. In this context, for example also a relative height in the longitudinal direction of the containers of a faulty printing head may be determined for the identification thereof.

Advantageously, at least one printing unit, and preferably several printing units and preferably all printing units, have at least two and preferably at least three printing heads, which are arranged offset from each other at least in the longitudinal direction of the container.

In a further advantageous embodiment, the holding device for the containers also includes an element, such as in particular a centring bell and gripping elements, so that the containers can be held in an accurate position relative to the printing units.

In a further advantageous embodiment, the apparatus also includes an association device that associates the inspection result with that holding device that held the container during the printing operation. Such an association not only of the printing unit, but also of the respective holding device may be advantageous because certain errors may also be caused by faulty holding devices, for example in the case of not accurately held containers.

Thus, for example, a container that is held askew may result in the print not being properly applied to the container, but for example askew in relation to a desired position.

In order to identify the holding device, several approaches are conceivable. Thus, for example, one or more printing units may output a signal with the print, which for example also includes a time stamp. From a time stamp, a conclusion can be made during inspection, if the machine speed is known, as to the holding device. It would also be possible to detect a machine position, for example a position of the carrier, at the time of printing. From this position, a conclusion can in turn be made as to the printing unit that has held the container just printed.

In a further advantageous embodiment, the apparatus comprises a control unit that controls at least one printing unit under consideration of the inspection result. Thus, in particular a control unit may be provided that is capable of adjusting out certain errors, such as errors like smudging of prints, fitting accuracy, register alignment and the like. It would further be possible to determine on the basis of an inspection that certain printing elements are faulty, and for replacing them in this case with different printing elements, in particular if they are redundantly present (see above).

In a particularly preferred embodiment, during identification of a faulty printed colour or printing head (in a vertical direction), a switchover may be made to an alternative printing design. This printing design will then not use the colour identified as being faulty, but will intentionally use a different design. In the case of a faulty holding device it is also possible to switch the holding device off or not to load it.

It is further possible not to treat the containers transported through a malfunctioning holding device and to guide instead the non-printed containers to a separate rejection belt to a conventionally working labelling machine.

In a further advantageous embodiment, also a statistics unit is provided that statistically evaluates the inspection results. Thus for example, the occurrence of certain errors in certain printing units may be statistically evaluated. Thus for example, it may be determined how often a printing unit that outputs a certain blue colour causes a certain error. Also, error frequencies may be associated with several printing units and/or also several holding devices.

If it is for example determined that a certain error occurs only when printing a container that is held by the 17^{th} holding device, it can be deduced therefrom that it may not be the printing unit that is faulty but the holding device. In this case, suitable countermeasures may be initiated.

The present invention is further directed to a method for printing containers. In this method, the containers are transported by means of a transport device along a specified transport path, and the containers are printed both by means of a first printing unit and by means of a second printing unit.

According to the invention, an inspection device located downstream of one of the printing units is used to inspect the containers, and the inspected containers and/or an inspection result is/are associated with at least one printing unit that has printed onto this container.

It is therefore also proposed in respect of the method to associate inspection results with certain printing units. In this way, countermeasures in the case of the occurrence of said errors can be taken more easily or in a targeted manner respectively. Advantageously, the consecutive printing units print at least partially onto the same regions of a container. As mentioned above, preferably different colour components of an image may be printed by the printing units.

In a further preferred method, information is carried along that indicates which printing unit has printed onto the respective container. Preferably, also information is recorded or carried respectively that determines the holding device that has held the printed container. This allows an association to be made not only in respect of a faulty printing unit, but also of a holding device that has held the respective container with the faulty print.

Advantageously, the inspection device is provided downstream of the transport device that guides the containers during printing.

Preferably, the transport device transports the containers along a circular path. In a further advantageous method, the inspection device outputs at least one piece of error information with regard to an applied print.

Preferably, at least one piece of information is output that is characteristic of the occurrence of a certain printing error. It would also be possible to output a piece of information that allows a conclusion to be made in respect of the corresponding error.

In a further advantageous method, the printing error is selected from a group of printing errors including a faulty spread of a printing liquid on the container, a faulty position of the first image element relative to a container, a faulty position of a first image element applied in a certain region of the container in relation to a second printing element applied in this certain region of the container, smudging of at least one image element, a failure of at least one nozzle element or printing element respectively of at least one printing unit, a faulty location of at least one image element in relation to the container and/or a colour error of the image element or combinations thereof. Spread is understood to be the propagation and surface distribution of liquids on surfaces, here in particular the distribution of printing ink (in particular on a plastics material surface).

Within the context of this advantageous method it is proposed to categorise individual errors so as to enable in this way countermeasures to be taken in a particularly simple manner. Such errors may, as mentioned above, be determined in particular by way of a captured image of the respective containers or the prints thereof.

In a further preferred method, a cause of error in at least one printing unit is associated with a determined printing error. Thus, for example, it may be determined as an error that the red component of the print has lines, and from this again a conclusion can be made that the printing elements, for example the printing nozzles of the printing unit dispensing the red colour, are faulty.

In a preferred method, the inspection device captures at least one image of the container to be inspected. Here, the inspection device preferably captures the container in a contactless manner. Advantageously, the inspection device captures several images of the container. Advantageously here, both colour images and black and white images may be captured.

In a further preferred method, the inspection device outputs at least one result that is characteristic of the print of the container. Thus for example, a spread of the print may be output as a result, wherein preferably an output indicating which printing unit has caused this error is also provided.

In a further advantageous method, the containers are transported by the transport device by means of a plurality of holding devices, and the inspection result is associated with that holding device that held the inspected container during the application of the image element concerned. This means that in this method not only a printing unit is identified, but it is also identified which holding device held the container concerned during the printing operation. In this way, it is also possible to identify any faulty holding devices.

In a further preferred method, at least one printing unit and preferably several printing units are controlled using an inspection result. Thus for example, a correction to the printing unit concerned may be initiated, preferably automatically, as a response to a certain detected error, for example, instead of a certain printing head, a redundantly provided further printing head may be used.

In a further preferred method, certain containers and in particular also incorrectly printed containers may be rejected after the inspection device, so that they will no longer get to a further processing station. In this embodiment, the inspection device may for example output a signal to a further rejection unit such as a pusher, which can eject any containers detected as being faulty from the container flow.

In a further advantageous method, a plurality of inspection results is evaluated in respect of at least one printing error. Thus, for example, it can be checked for a plurality of containers whether the corresponding prints have a certain error. Also a profile of this error can be viewed. Further, it is possible to define tolerance limits in respect of a certain criterion. As long as the inspected containers are within these tolerance criteria, a container is still declared as being proper, but as soon as inspected results are outside of these limits, error messages may be output.

Apart from that it is also possible to form a profile of certain inspection results or of measurement values respectively. Thus for example it may be checked whether a certain error occurs repeatedly or even gets worse, for example whether there is a drift away from certain nominal values.

By way of this evaluation of the errors it can also be checked whether a certain error can be attributed to a certain printing unit or maybe to a corresponding holding device. In a further advantageous method, at least one printing unit is controlled using the inspection result. Thus for example, the printing heads of a certain printing unit may be controlled under consideration of the inspection result. It would therefore for example be possible to capture an image of a container, subsequently to adjust a printing unit, subsequently again inspecting a corresponding container and carrying out a further adjustment. It is thus possible to carry out in particular an interactive adjustment of the printing heads. It is also possible to carry out in this way an adjustment of print templates.

In other words, the printing units can be adjusted on the basis of the inspection result.

In a further advantageous embodiment, a learning operation is provided, during which the individual printing units can, preferably automatically, be matched to each other. Thus for example, a certain container could initially pass through all of the printing units and could subsequently be inspected by the inspection device. The inspection device can output commands to the controls of the individual printing units in respect of certain changes, for example in respect of certain positional changes. Once an adjustment of the printing heads has been carried out, a container can again be printed and again be inspected. On the basis of this second inspection result, a further adaptation of the printing units can be carried out. In this way finally, a complete adjustment of the individual printing units themselves and also of the printing units in respect of each other can be carried out.

In a further preferred method, the containers can be post-treated, for example tempered, after printing. It would thus also be possible that for example an applied print is dried. This may for example be carried out by applying UV light.

It is further possible here to use the inspection device also to detect any faulty drying processes, such as by means of an at least partially smudged image.

It would further also be possible to provide the user with warnings, in particular when specified tolerance limits are exceeded. Also, other measures could be initiated, up to a machine stop.

Further advantages and embodiments will result from the attached drawings, wherein:

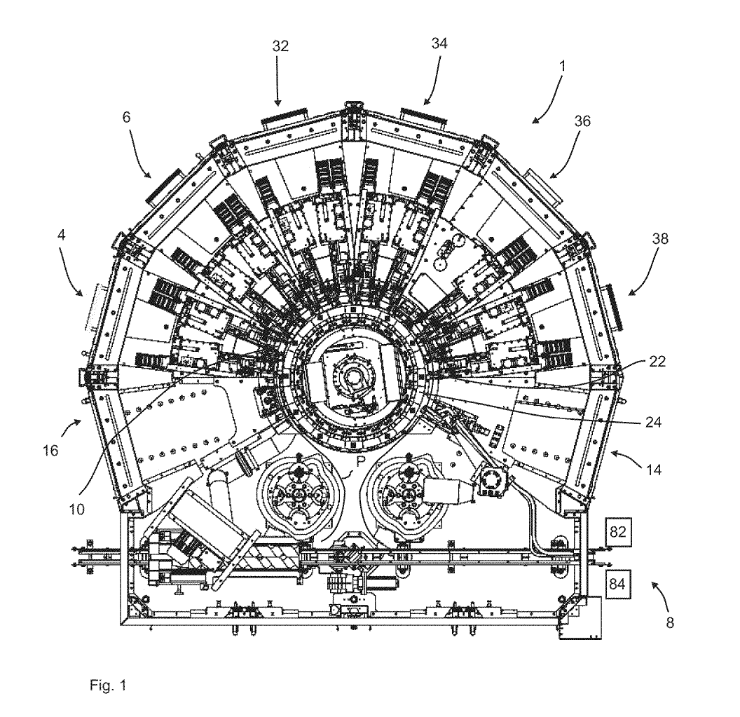

FIG. 1 shows a schematic view of an apparatus according to the invention for printing containers, and

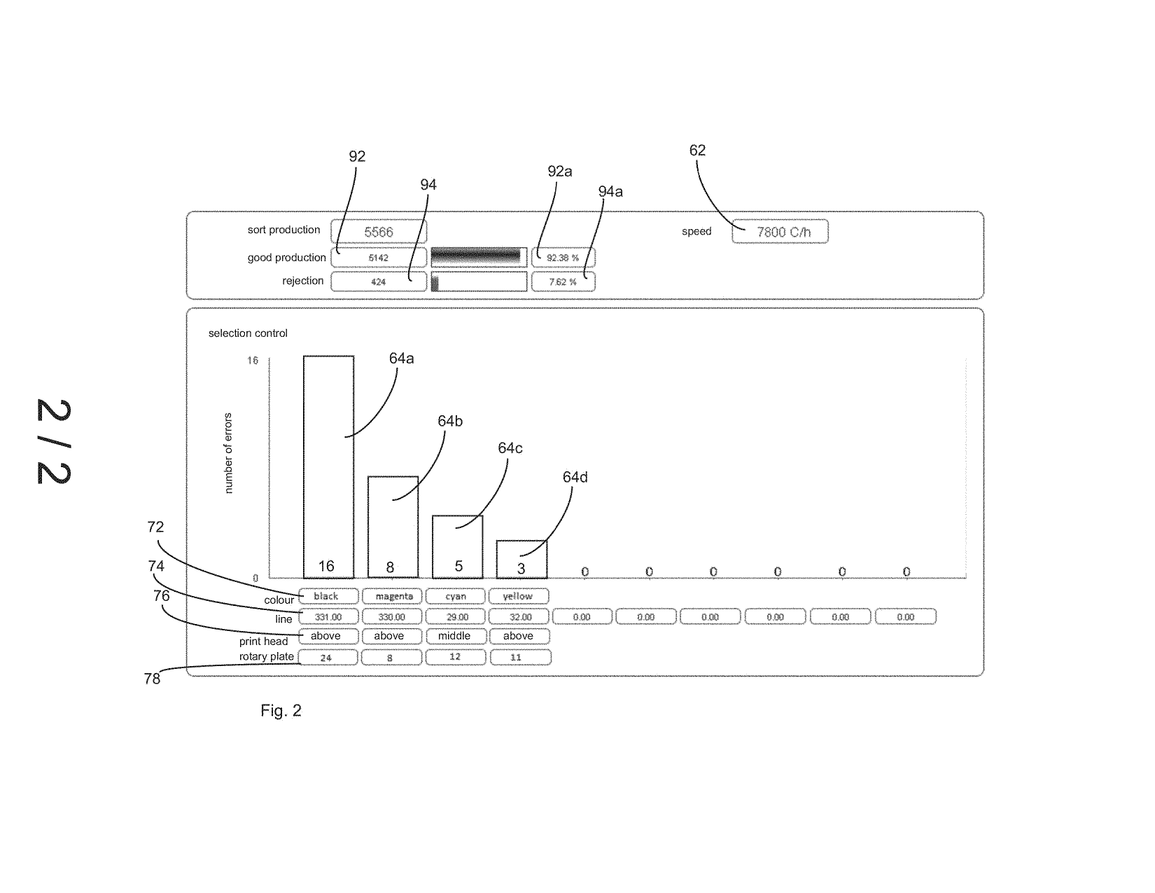

FIG. 2 shows a view for illustrating an evaluation of the printing quality.

FIG. 1 shows a schematic view of an apparatus according to the invention for printing onto containers. Here, containers 10 are transported by holding elements 22 along a circular transport path. These holding elements 22 are provided on a rotatable carrier which is not shown here in detail. The holding elements have here preferably also rotary plates that can rotate the containers also during the printing operation, so that it is also conceivable to apply a print onto the container over the entire circumference thereof. Further, the holding elements may also have centring elements such as for example centring bells, so that the containers can be clamped between these rotary plates and the centring bells. Apart from that, the holding elements may also include markings that allow an identification of the respective holding element.

In this context it would be conceivable for the transport unit to guide the containers continuously past the individual printing units. However, also a cycled transport of the containers would be conceivable, in which it is for example possible to stop every time the containers are at the respective printing element, so that a print can be applied in this position. Preferably, the containers are plastics material containers or glass containers or in particular plastics material bottles or glass bottles.

During this transport, the containers 10 run through or pass through respectively a plurality of units 16, 4, 6, 32, 34, 36 and 38, in each of which different treatment steps are carried out on the containers. Unit 16 is here preferably a monitoring and anti-static unit, i.e. it is possible in this station to check whether the containers have for example static charge carriers. Such static charge carriers might be hindering the printing operation. Thus, such static charge carriers could be removed in the station 16. Reference sign P relates to the transport path (only partially shown) of the containers through the apparatus. It is possible here for a pitch between the individual containers to be increased prior to the containers reaching the individual printing units.

Reference sign 4 relates to a first printing unit which applies here for example a yellow print onto the container 10 or to a certain region of the container 10. Reference sign 6 relates to a second printing unit located, in the transport direction of the containers 10, downstream of the first unit 4, which second printing unit applies a second colour component, for example magenta, onto the containers, preferably in the same region in which the yellow colour component has already been applied. Reference sign 32 identifies a third printing unit that applies a third component of a colour print, here for example the colour component cyan.

Subsequently, the containers are guided past a further printing unit 34, which applies for example black colour or a black component respectively and in particular a front print.

Reference sign 36 identifies a further printing unit that can apply for example a white printing component to a rear side of the container. Finally, the printing unit 38 can apply a black component also to the rear side of the container.

Finally, reference sign 14 identifies a drying unit used for drying the prints on the container surfaces. Preferably, this drying unit 14 includes a UV radiation element that radiates UV light onto the containers for drying the latter.

Downstream of the individual printing units, an inspection device generally identified with 8 is located. This has here a first camera 82 that is suitable for capturing colour images and which thus checks in particular the colour prints. Reference sign 84 identifies a second camera unit, which is in particular a black and white camera that is correspondingly suitable for checking the operation of printing units 34, 36 and 38. These two image capturing devices may here be provided on different sides of the transport path of the containers.

Reference sign 12 schematically identifies an association device that associates an inspection result captured by the inspection device 8 with at least one printing unit. Besides, this inspection result may also be associated with several printing units. This inspection result may for example be an error condition of a printed image. In this context, the association device is in particular able to associate not only the unit that has caused the error. Preferably also information in respect of how this error can be eliminated can be output. Further, the association device may also associate other faulty units, such as for example the anti-static unit 16 mentioned above. Apart from that, certain errors may also be associated with a faulty behaviour of the drying device.

FIG. 2 shows a possible illustration for evaluating printing results. To this end, the apparatus may have an indicator such as a display. Apart from the information shown in FIG. 2, in each case also an image of the containers 10 or the printed regions thereof may be output. In this context, also the occurrence of faults may already be visualised to the user, for example by depicting where a certain error (which may not be immediately detectable on the image) is located.

In this context, the user may initially specify which of the above-mentioned printing units is to be inspected. On the basis of the results of the image capturing devices 82 and 84, the error frequencies may subsequently be selected. Reference sign 72 identifies here the information as to which colour component (yellow, magenta, cyan, black, white) was evaluated, wherein this in turn allows a conclusion to be made in respect of the corresponding printing unit. For example, if as shown in FIG. 2 the colour component should be magenta, then this means that correspondingly printing unit 6 is inspected.

The presentation elements 64a-64d indicate error frequencies, with which a certain error occurs. Thus, for example, an error in the black component occurs with a number of 16.

By means of a further presentation element 74 it may also be indicated where a certain error occurs, for example in which particular printing line. On the basis of this printing line it can be checked which printing element is very likely to be faulty. Thus, preferably also the evaluation of an image captured by the image capturing device 82 and/or 84 is carried out in a spatially resolved manner, for example resolved by image lines.

The presentation element 76 additionally specifies which printing head of a certain unit is faulty or has caused the error respectively. In the exemplary case shown, it may be the upper printing head that is faulty. A corresponding response could be to replace this upper printing head.

The presentation element 78 could further be used to indicate which rotary plate or which holding device respectively held the container when the error occurred. If for example the rotary plate or the holding device number 24 respectively, as shown in FIG. 2, shows failures with a particularly high error frequency, then a conclusion can be made in respect of a corresponding faulty holding device.

Thus, error frequencies can also be output as a function of several criteria, in particular as a function of the colour (i.e. the printing unit), the rotary plate or the holding device respectively, the dot line or the respective printing head.

Thus, different types of evaluation are conceivable. Thus, for example, it could be determined how many containers have been incorrectly printed by the first printing unit. Here it could again be determined by which holding elements the containers detected to be faulty are held during printing. It may also be determined which printing element or which printing head respectively, of the first printing unit has caused the error.

Also, a processor device can automatically determine the error cause. If for example it is determined in a first step that an image is faulty, it could initially be determined which printing unit and/or which holding device can be associated with this error. If for example a certain error is associated with several printing units but with only one particular holding element, then this indicates that (only) this holding element is faulty.

In addition, also an overall statistic can be output, i.e. it can be indicated how high the proportion of the rejected containers is in relation to the overall production and also in relation to the non-rejected containers. The presentation element 94 indicates for example that 424 containers were rejected and 5162 containers (output element 92) were found to be good. With regard to the information 92a and 94a it is also possible to provide corresponding percentage information. The display element 62 finally outputs information regarding the overall production speed.

It would further be possible to define limit values, i.e. error frequency limits, from which onwards further measures will be taken, such as for example switching off the machine for repair. Further, warning thresholds could be defined which indicate that in the case of excessively high rejections of faulty containers certain countermeasures have to be initiated, such as for example a replacement of certain printing heads.

Altogether therefore, in a preferred method, an association of the error frequency according to at least two criteria is carried out, wherein these criteria are selected from a colour of the print, an indication of the holding device, a dot line or a printing head of one or more particular printing units.

The Applicant reserves the right to claim all of the features disclosed in the application documents as being essential to the invention, in as far as they are novel over the prior art either individually or in combination. It is further pointed out that also features were described in the individual figures, which may be advantageous by themselves. A person skilled in the art will immediately recognise that a certain feature described in a figure may also be advantageous without adopting further features from this figure. A person skilled in the art will further recognise that advantages may also be gained by combining a plurality of features shown in individual or in different figures.

### LIST OF REFERENCE NUMERALS

4 First printing unit
6 Second printing unit
8 Inspection device
10 Containers
12 Association device
14 Drying unit
22 Holding elements, holding devices
24 Carrier
32 Third printing unit
34, 36, 38 Printing unit
62 Display element
64a, b, c, d Presentation element
72, 74, 76, 78 Presentation element
82 Image capturing device, output element
84 Image capturing device
92, 94 Output element
92a, 94a Information
P Transport path

1. An apparatus for printing onto containers, comprising a transport device that transports the containers to be printed along a specified transport path, wherein the transport device includes a carrier and a plurality of holding devices provided on said carrier for holding the containers to be printed in such a way that the containers to be printed can be transported in an individualized manner, having a first printing unit that prints a specified image element onto the containers, having a second printing unit that is provided along the transport path of the containers after the first printing unit and prints a second image element onto the containers already printed with the first printing element, wherein
the apparatus includes an inspection device provided downstream of the printing units in the transport direction of the containers, which inspection device inspects the print provided on the containers, as well as an association device that associates an inspection result of the inspection device with the printing units.

2. The apparatus as claimed in claim 1, wherein at least one printing unit is an inkjet printing unit.

3. The apparatus as claimed in claim 1, wherein the apparatus includes a third printing unit that is provided after the second printing unit along the transport path of the containers and prints a third image element onto the containers already printed with the first printing element and the second printing element.

4. The apparatus as claimed in claim 1, wherein at least one printing unit is mounted to be stationary.

5. The apparatus as claimed in claim 1, wherein the inspection device has a first image capturing device that is suitable for capturing spatially resolved color images.

6. The apparatus as claimed in claim 5, wherein the inspection device has a second image capturing device suitable for capturing spatially resolved images.

7. The apparatus as claimed in claim 5, wherein the association device associates the inspection result with the holding device that held the inspected container during the printing operation.

8. The apparatus as claimed claim 5, wherein the apparatus has a control unit that controls at least one printing unit under consideration of the inspection result.

9. A method for printing containers, comprising transporting the containers by a transport device along a specified transport path, and printing the containers both by a first printing unit and by a second printing unit,
and inspecting by
an inspection device located downstream of one of the printing units the containers, wherein the inspected containers and/or an inspection result is/are associated with at least one printing unit that has printed onto the container.

10. The method as claimed in claim 9, wherein the inspection device outputs at least one piece of information that is characteristic of the occurrence of a certain printing error.

11. The method as claimed in claim 10, wherein the printing error is selected from a group of printing errors that includes a faulty spread of a printing liquid on the container, a faulty position of a first printing element relative to a second printing element, a faulty position of a first printing element applied to a certain region of the container in respect of a second printing element applied to this particular region of the container, smudging of at least one printing element, a failure of at least one nozzle element of at least one printing unit, a faulty location of at least one printing element in relation to the container, a color error of the printing element, combinations thereof and the like.

12. The method as claimed in claim 10, wherein a determined printing error is associated with an error cause of at least one printing unit.

13. The method as claimed in claim 9, wherein the inspection device captures at least one image of the container to be inspected.

14. The method as claimed in claim 9, wherein the transport device transports the containers by a plurality of holding devices, and the inspection result is associated with that holding device that held the inspected container during the application of the printing elements.

15. The method as claimed in claim 9, wherein a plurality of inspection results is evaluated in respect of at least one printing error.
